(19) United States
(12) Patent Application Publication
(10) Pub. No.: US 2015/0256491 A1
(43) Pub. Date: Sep. 10, 2015

(54) RECIPIENT SUGGESTION SYSTEM

(71) Applicant: MICROSOFT CORPORATION, Redmond, WA (US)

(72) Inventors: David Eatough, Redmond, WA (US); Jeffrey Wall, Sammamish, WA (US); Ian Petersen, Seattle, WA (US); Brion Stone, Seattle, WA (US)

(21) Appl. No.: 14/197,079

(22) Filed: Mar. 4, 2014

(51) Int. Cl. H04L 12/58

(52) U.S. Cl. CPC H04L 51/046

(57) ABSTRACT

A system that suggests recipients for a target document based on similarity of document data is provided. The system receives an indication of the target document. The system identifies documents that are similar to the target document based on a comparison of document data of the target document to document data of documents in a corpus of documents. The system then identifies entities associated with the identified documents. The system then suggests that one or more of the identified entities be considered as recipients for the target document. The system may also suggest recipients based on a recipient query. When a response to a prompt for a recipient does not match an entity in an address store, the system identifies an entity to suggest by using the response as a recipient query to identify an entity that matches the recipient query.

### BACKGROUND

Electronic communications such as electronic mail messages, invitations, instant messages, and text messages are sent to the electronic mail addresses of the intended recipients. The sender of such an electronic communication typically needs to enter the full electronic mail address (e.g., “Jane.Doe@acme.com”) of each recipient. Most electronic mail systems provide address stores (e.g., address books or contact lists) that map the names of contacts to their electronic mail addresses. For example, an address book may map the name Jane Doe to the electronic mail address “Jane.Doe@acme.com.” To facilitate entry of the electronic mail address of a recipient, electronic mail systems allow the sender to enter a name of a contact in the to-field to designate a recipient. When a name is entered, electronic mail systems access the address book of the sender to retrieve the entry for the contact with that name and use the corresponding electronic mail address as the address of the intended recipient. A similar approach is used to identify the electronic mail addresses of contacts who are being invited to a meeting or some other event.

Senders may repeatedly send different electronic communications to the same group of people. For example, a president of a company may frequently send electronic mail messages to the members of the board of directors of the company. Electronic mail systems allow for the creation of distribution lists or contact groups. To create a distribution list, a person enters the name of the list (e.g., “Board of Directors”) and then enters the names of the contacts to be included as members of the list. To send an electronic mail message to each contact in a distribution list, the sender enters the name of the distribution list in the to-field. The electronic mail system recognizes the name as a distribution list, retrieves the names of the members of the list, and then retrieves the electronic mail address of each member from an address book.

Electronic mail systems may provide limited assistance with trying to resolve the name of an entity. If a name entered by the sender in a to-field cannot be resolved to a single entity (e.g., a contact or a distribution list), electronic mail systems may display a list of possible entities that might be the intended entity. For example, if a person enters the name “J Do,” an electronic mail system may list “Jane Doe,” “John Doe,” and “Jeremy Dornier” and give the sender an opportunity to select the name of the intended recipient to be added to the to-field as a current recipient.

Although the use of address books, distribution lists, and name resolution assistance facilitate the sending of electronic communications, it can still be difficult for a sender to remember the names or even know the names of all people who should receive an electronic communication. For example, the president of a company may want to send an electronic mail message to the assistant of the director of marketing. Although the president knows the name of the marketing director, the president may not know or remember the name of the director's assistant.

### SUMMARY

In some embodiments, a system for suggesting recipients for a target document based on similarity of document data is provided. The system receives an indication of the target document. The system identifies documents that are similar to the target document based on a comparison of document data of the target document to document data of documents in a corpus of documents. The system then identifies entities associated with the identified documents. The system then suggests that one or more of the identified entities be considered as recipients for the target document.

In some embodiments, a system for suggesting recipients for a target electronic communication based on a recipient query is provided. The system prompts a user for entry of a recipient of the target electronic communication and then receives a response to the prompting. When the response treated as a name matches an entity in an address store, the system adds the matching entity as a recipient of the target electronic communication. When the response does not match an entity in the address store, the system identifies an entity to suggest as a recipient of the target electronic communication by using the response as a recipient query to identify an entity that matches the recipient query.

### BRIEF DESCRIPTION OF THE DRAWINGS

FIG. 1 illustrates a display page of an electronic mail system with suggested recipients based on document data in some embodiments.

FIG. 2 is a display page of an electronic mail system with suggested recipients based on a recipient query in some embodiments.

FIG. 3 is a block diagram illustrating components of the recipient suggestion system in some embodiments.

FIG. 4 is a flow diagram that illustrates processing of the suggest user interface component of the recipient suggestion system in some embodiments.

FIG. 5 is a flow diagram that illustrates the processing of the suggest recipients component of the recipient suggestion system in some embodiments.

FIG. 6 is a flow diagram that illustrates the processing of a field suggest recipients component of the recipient suggestion system in some embodiments.

FIG. 7 is a flow diagram that illustrates the processing of the indexer component of the recipient suggestion system in some embodiments.

FIG. 8 is a high-level flow diagram that illustrates the processing of the recipient suggestion system in some embodiments.

FIG. 9 is a high-level flow diagram that illustrates the processing of a recipient search component of the recipient suggestion system in some embodiments.

### DETAILED DESCRIPTION

A method and system for suggesting recipients to receive an electronic communication is provided. In some embodiments, a recipient suggestion system suggests recipients based on their association with documents that are similar to a target document. To suggest recipients, the recipient suggestion system receives an indication of a target document. For example, the target document may be a target electronic mail message. The recipient suggestion system compares document data of the target document with the document data of documents in a corpus of documents to identify documents that are similar to the target document. For example, the recipient suggestion system may compare the content of the target electronic mail message to the content of electronic mail messages that the sender has sent or received. The recipient suggestion system then identifies entities associated with the identified documents that are similar. For example, the entities associated with a similar electronic mail message may be the parties to the electronic message as identified in the from-field, to-field, cc-field, and bcc-field. In the case of a document that is not an electronic mail message, the associated entities may include the authors, editors, reviewers, and readers of the document. The recipient suggestion system then suggests that the identified entities be considered as recipients of the target document. For example, the recipient suggestion system may display a list of the identified entities adjacent to the to-field of an electronic mail message and allow the sender to select one or more suggested recipients to add as current recipients of the target electronic mail message. In this way, the recipient suggestion system identifies suggested recipients based on entities associated with documents that are similar to the target document.

In some embodiments, the recipient suggestion system allows a user to enter a generalized recipient query in a recipient field, conducts a people finder search to identify people that match the recipient query, and suggests those people as recipients. The recipient suggestion system may prompt the user for entry of a recipient of a target electronic communication. For example, the recipient suggestion system may prompt the user by displaying a to-field of an electronic mail message. The recipient suggestion system then receives a response to the prompt such as the entry of the name of the recipient (e.g., Jane Doe) or a recipient query (e.g., “Board of Directors” or “Jane Doe's assistant”). The recipient suggestion system may first attempt to determine whether the response matches an entity in the user's address book. If it does, the recipient suggestion system resolves the response to that entity. If it does not, the recipient suggestion system submits the response as a people query to a people finder search engine. A people finder search engine may search various information sources to identify people who match the people query. The information sources may include an employee database of a company, a membership database of an organization, social or business networks, the World Wide Web, publicly available government databases, and so on. For example, if the response is “Board of Directors” and the response cannot be resolved to a person or distribution list, then the recipient suggestion system may search a company database to identify people whose profiles in some way relate to “Board of Directors.” The recipient suggestion system then displays the entities that match the search query as suggested recipients of the target electronic communication.

In some embodiments, the recipient suggestion system may determine that a document is similar to a target document based on associated entities that are common to both documents. For example, if the target document is an electronic mail message with three current recipients specified so far, the recipient suggestion system may consider electronic mail messages that have those same three parties to be similar. In such a case, the recipient suggestion system may suggest parties to those other electronic mail messages that are not one of the three current recipients as recipients. For example, if Jane Doe, John Smith, and Bob Jones have been entered by the sender as current recipients of a target electronic mail message, the recipient suggestion system may consider an electronic mail message sent to those three recipients along with Tom Smith to be similar. In such a case, the recipient suggestion system may suggest that Tom Smith be considered as a recipient.

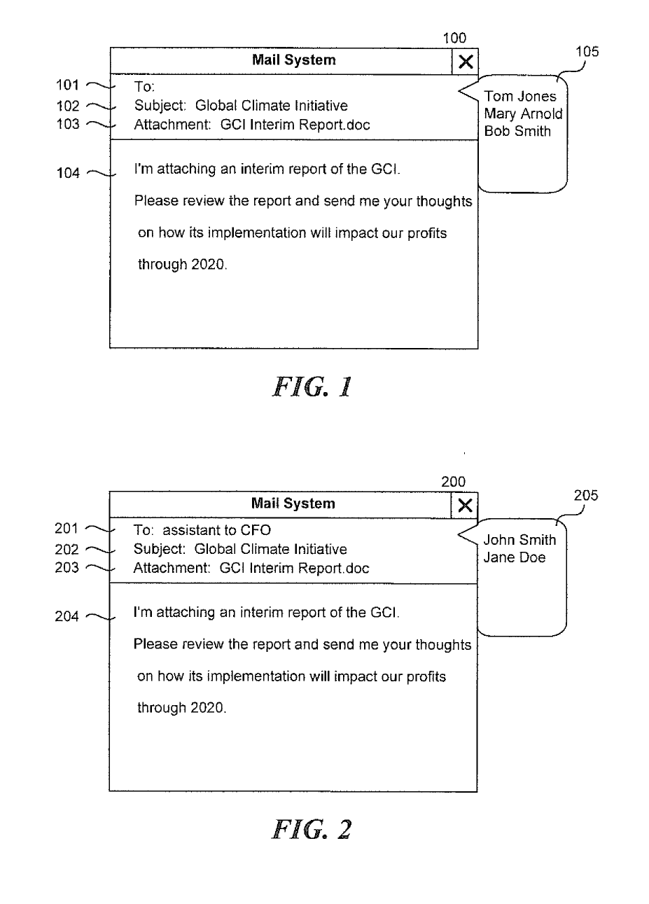

FIG. 1 illustrates a display page of an electronic mail system with suggested recipients based on document data in some embodiments. Display page 100 includes a to-field 101, a subject-field 102, an attachment-field 103, a content-field 104, and a suggestion area 105. The to-field represents a prompt for recipients, the subject-field contains the subject of the electronic mail message, and the attachment-field contains the name of an attached document. The content-field contains the text of the electronic mail message. The suggestion area displays suggested recipients as identified by the recipient suggestion system. As the user enters the subject and content and attaches documents, the recipient suggestion system may identify electronic mail messages that have similar subjects, content, and attachments and suggest parties to those identified electronic mail messages as recipients. The recipient suggestion system may dynamically update the list of suggested recipients as the user enters the subject and content and attaches documents. Alternatively, the recipient suggestion system may provide a button through which the sender can request suggestions for recipients. The recipient suggestion system may allow the sender to select a suggested recipient for adding to the to-field as a current recipient. The recipient suggestion system may also allow the sender to select a suggested recipient to obtain more information about the suggested recipient such as title, employer, a list of electronic mail messages to which the suggested recipient was a party, and so on.

FIG. 2 is a display page of an electronic mail system with suggested recipients based on a recipient query in some embodiments. Display page 200 includes a to-field 201, a subject-field 202, an attachment-field 203, a content-field 204, and a suggestion area 205. The sender of the electronic mail message has entered a response of “assistant to CFO” in the to-field. If the recipient suggestion system cannot resolve the response to a contact in the sender's address book or to a distribution list, the recipient suggestion system submits the response as a people query to a people finder search engine. In this example, the people finder search engine returned the names that are displayed in the suggestion area. The sender can then select a name to add the suggested recipient as a current recipient or to find additional information about that suggested recipient.

In some embodiments, the recipient suggestion system may be used by an organization that receives electronic communications from external parties to route the electronic communications to parties internal to the organization. For example, when an electronic mail message is received by an organization, the recipient suggestion system may be used to identify similar electronic mail messages and suggest the recipients of those electronic mail messages as recipients for the received electronic mail message. The recipient suggestion system may also automatically forward the received electronic mail message to the suggested recipients.

In some embodiments, the recipient suggestion system may use various techniques for assessing the similarity between documents. For example, the recipient suggestion system may select keywords from the document data of the target document and then rank the documents of the corpus using a term-frequency-by-inverse-document-frequency (td*idf) metric, such as BM25. The recipient suggestion system may maintain an index that maps words to documents in the corpus to facilitate the identification of similar documents without having to search through each document. Rather than using words, the recipient suggestion system may identify documents based on n-grams of characters. For example, the index may map sequences of n-characters to the documents that contain those sequences. The recipient suggestion system may also weight scores generated based on different types of document data. For example, similarity between the subject of electronic mail messages may be weighted higher than similarity between content of the electronic mail messages. Generally, the recipient suggestion system generates sub-scores for similarity derived from similar parties (p), subjects (s), attachments (a), and content (b) as represented by the following equation:

S^{r}=+wₚS^{r}ₚ+wₛSₛ^{r}+wₐSₐ^{r}+w_{b}S_{b}′

where S′ represents the score for document r, wₓ represents the weight for sub-score x, and Sₓ^{r} represents the sub-score for x. The recipient suggestion system may learn the weights over time based on user feedback of senders selecting or not selecting suggested recipients. Alternatively, the weights may be manually configured for each organization or user. The recipient suggestion system may set the sub-score for similar parties according to the following equation:

$${S}_{p}^{r} = \frac{{c}^{2}}{te * {e}^{r}}$$

where c represents the number of parties in common between the target electronic mail message and electronic mail message r, te represents the number of recipients of the target electronic mail message, and e^{r} represents the number of recipients of the electronic mail message r. The recipient suggestion system may also use a decay factor to reduce the scores for documents so that more recent documents are given higher scores.

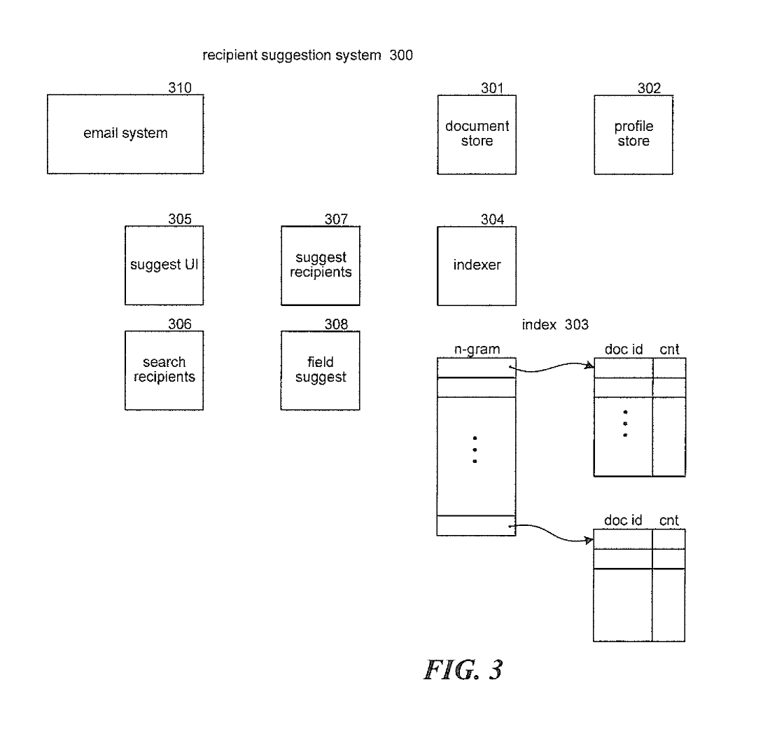

FIG. 3 is a block diagram illustrating components of the recipient suggestion system in some embodiments. The recipient suggestion system 300 includes a document store 301, a profile store 302, and an index 303. The recipient suggestion system also includes an indexer 304, a suggest user interface component 305, a search recipients component 306, a suggest recipients component 307, and a field suggest component 308. The recipient suggestion system may interface with an electronic mail system 310 or may be implemented as part of an electronic mail system. The document store contains the documents of the corpus (e.g., electronic mail messages of a user). The profile store contains profiles of people associated with an organization. The index contains a mapping of n-grams to the documents in the document store that contain those n-grams. Each entry in an n-gram table corresponds to an n-gram and contains a reference to a document table that lists the documents that contain that n-gram and a count of the occurrences of the n-gram within the document. The indexer may run periodically or when the document store is updated to update the index based on changes to the document store. The suggest user interface component controls the display of suggested recipients in a suggestion area as illustrated, for example, in FIGS. 1 and 2. The search recipients component is passed a people query and submits the people query to a people finder search engine (not illustrated) to identify people who match the people query to suggest as recipients. The suggest recipients component identifies suggested recipients based on similarity of the parties, subjects, attachments, and/or content of documents in a document corpus to the document data of a target document and ranks the suggested recipients. The field suggest component is passed an indication of the field and identifies similar documents based on that field and then generates a sub-score for the field for each of the entities associated with those similar documents.

The computing devices and systems on which the recipient suggestion system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the recipient suggestion system. The data transmission media is used for transmitting data via transitory, propagating signals or carrier waves (e.g., electromagnetism) via a wired or wireless connection.

The recipient suggestion system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the recipient suggestion system may be implemented in hardware using, for example, an application-specific integrated circuit (“ASIC”).

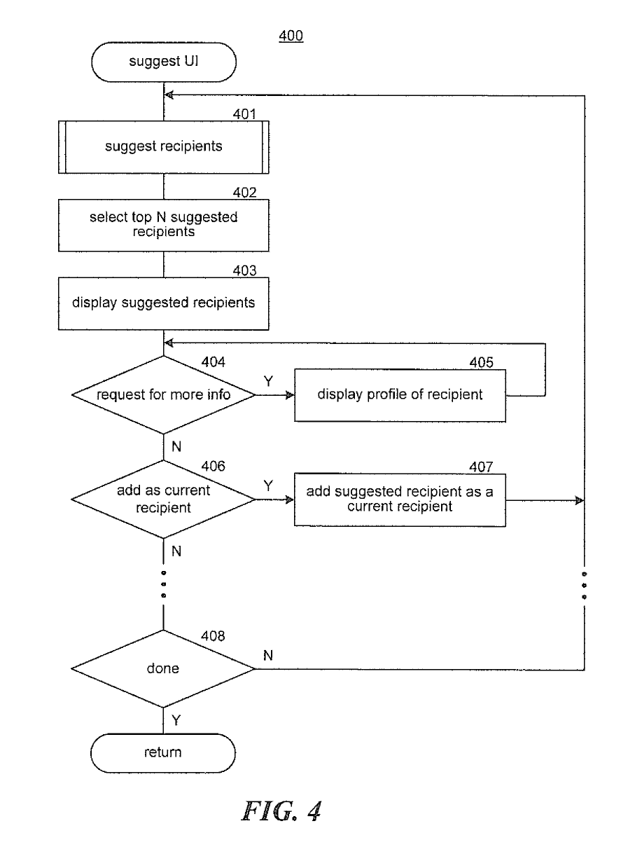

FIG. 4 is a flow diagram that illustrates processing of the suggest user interface component of the recipient suggestion system in some embodiments. The suggest user interface component 400 is passed an indication of a document and suggests recipients to a sender of the document. In block 401, the component invokes a suggest recipients component to identify recipients to suggest to the sender. In block 402, the component selects the top-ranked suggested recipients returned by the suggest recipients component. In block 403, the component displays the names of the suggested recipients (e.g., people or distribution lists) in the suggestion area. In decision block 404, if the sender requests more information about a suggested recipient, then the component continues at block 405, else the component continues at block 406. In block 405, the component displays profile information related to the suggested recipient and then loops to block 404 to wait for input from the sender. In decision block 406, if the sender indicates to add a suggested recipient as a current recipient, then the component continues at block 407, else the component continues at block 408 in block 407, the component adds the suggested recipient as a current recipient and then loops to block 401 to suggest additional recipients. The recipient suggestion system may update the list of suggested recipients as the current recipients change and other document data changes. In decision block 408, if the processing of the suggested recipients is complete, then the component returns, else the component loops to block 401 to suggest additional recipients.

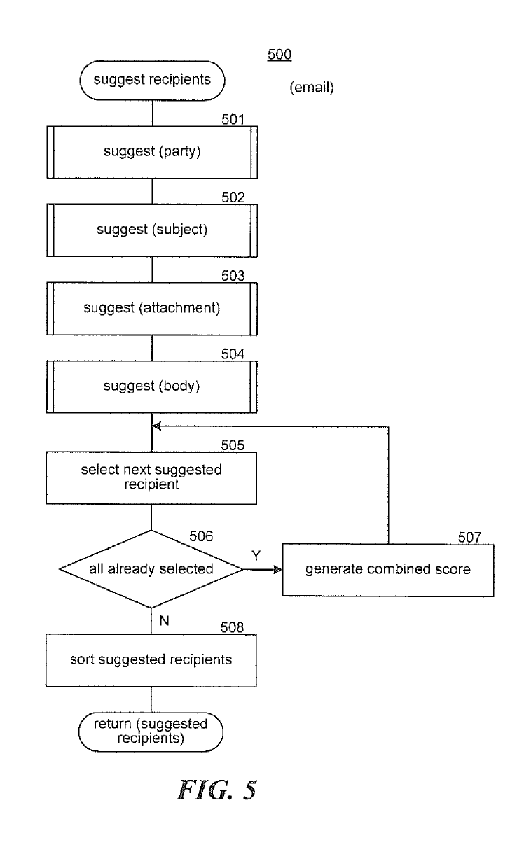

FIG. 5 is a flow diagram that illustrates the processing of the suggest recipients component of the recipient suggestion system in some embodiments. The suggest recipients component 500 is passed an indication of a target document and returns an ordered list of suggested recipients. In blocks 501-504, the component invokes the field suggest recipients component passing an indication of a field, such as party, subject, attachment, and content, and receiving in return sub-scores for suggested recipients for that field. In blocks 505-507, the component loops combining the sub-scores for each suggested recipient. In block 505, the component selects the next suggested recipient. In decision block 506, if all the suggested recipients have already been selected, then the component continues at block 508, else the component continues at block 507. In block 507, the component combines the sub-scores for the selected recipient to generate a combined score for the selected recipient and then loops to block 505 to select the next suggested recipient. In block 508, the component sorts the suggested recipients based on their combined scores and then returns the sorted list of suggested recipients.

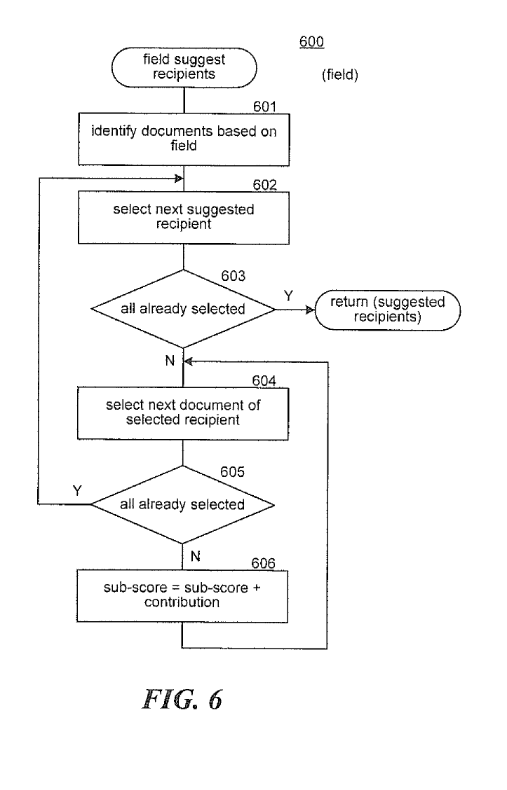

FIG. 6 is a flow diagram that illustrates the processing of a field suggest recipients component of the recipient suggestion system in some embodiments. The field suggest recipients component 600 is passed an indication of a field, such as party, subject, attachment, and content, and identifies similar documents based on that field and then generates a sub-score for entities associated with those documents. In block 601, the component identifies documents based on the field that is passed. In blocks 602-606, the component loops generating scores for suggested recipients that are entities associated with the identified documents. In block 602, the component selects the next suggested recipient. In block 603, if all the suggested recipients have already been selected, then the component returns the suggested recipients along with their sub-scores for the field, else the component continues at block 604. In block 604, the component selects the next document associated with the selected recipient. In decision block 605, if all the documents have already been selected, then the component loops to block 602 to select the next suggested recipient, else the component continues at block 606. In block 606, the component generates a sub-score by aggregating the contribution from the selected document and then loops to block 604 to select the next document for the selected suggestion recipient.

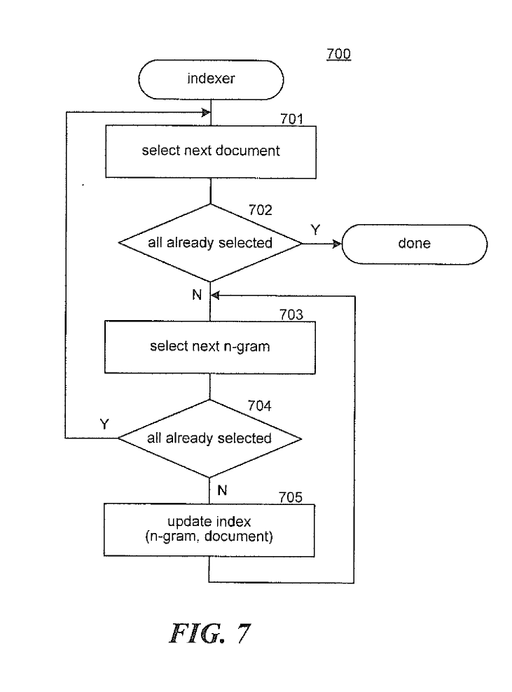

FIG. 7 is a flow diagram that illustrates the processing of the indexer component of the recipient suggestion system in some embodiments. The indexer component 700 is invoked to update the index based on changes to the document store. In block 701, the component selects the next document of the document store. In decision block 702, if all the documents have already been selected, then the component completes, else the component continues at block 703. In block 703, the component selects the next n-gram of the selected document. In decision block 704, if all the n-grams for the selected document have already been selected, then the component continues at block 701 to select the next document, else the component continues at block 705. In block 705, the component updates the index to the selected n-gram and document and then loops to block 703 to select the next n-gram.

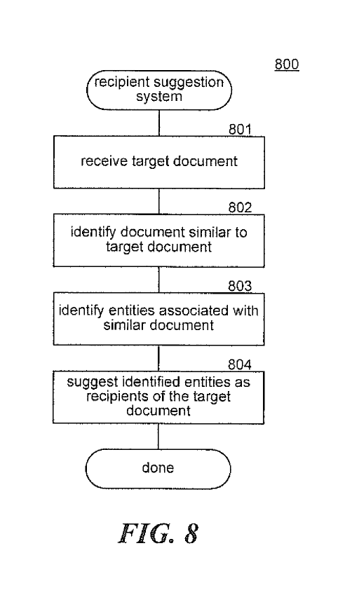

FIG. 8 is a high-level flow diagram that illustrates the processing of the recipient suggestion system in some embodiments. The recipient suggestion system 800 suggests recipients based on entities associated with documents that are similar to a target document. In block 801, the system receives the target document. In block 802, the system identifies documents that are similar to the target document. In block 803, the system identifies entities associated with those similar documents. In block 804, the system suggests the identified entities as recipients of the target document and completes.

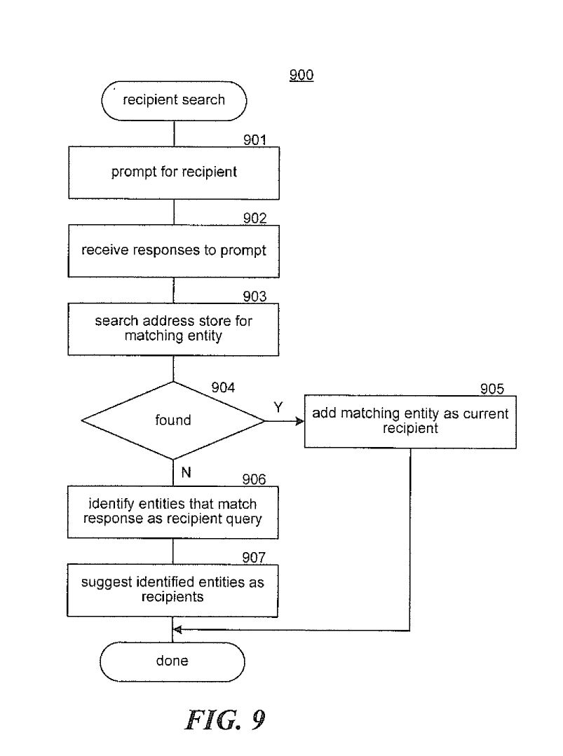

FIG. 9 is a high-level flow diagram that illustrates the processing of a recipient search component of the recipient suggestion system in some embodiments. The recipient search component 900 allows a user to enter a recipient query when prompted for the name of a recipient and suggests entities that match the recipient query as recipients. In a block 901, the component prompts for a recipient. In block 902, the component receives a response to the prompt. In block 903, the component searches an address store for an entity that matches the response, treating the response as the name of a contact. In decision block 904, if a matching entity was found, then the component continues at block 905, else the component continues at block 906. In block 905, the component adds the matching entity as a current recipient for the target document and then completes. In block 906, the component identifies entities that match the response treating the response as a recipient query. In block 907, the component suggests the identified entities as recipients and then completes.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, the recipient suggestion system may consider a distribution list as a single entity associated with an electronic communication or may consider each member of the distribution list as a separate entity. The user interface of the recipient suggestion system may provide a voice interface through which a sender can speak content, names of recipients, recipient queries, and so on and hear the names of the suggested recipients. The recipient suggestion system may also combine the capabilities of the suggesting recipients based on document similarity with suggesting recipients based on a recipient search. For example, when a sender enters a recipient search, the recipient suggestion system may identify matching entities and identify entities associated with similar documents. The recipient suggestion system may generate a combined list of the identified entities, a list that contains only entities that are both a matching entity and an associated entity (e.g., ranked based on a combination of a matching score returned by a people finder search engine and a similarity score based on document similarity), a list of matching entities that are ranked in part based on scores derived from document similarity, and so on. Accordingly, the invention is not limited except as by the appended claims.

I/we claim:

1. A computer-readable storage medium storing computer-executable instructions for controlling a computing device to suggest recipients for a document, the computer-executable instructions comprising instructions to:
receive an indication of a target document having document data;
identify documents that are similar to the target document based on a comparison of the document data of the target document to document data of documents in a corpus of documents;
identify entities associated with the identified documents; and
provide a suggestion that one or more of the identified entities be considered as recipients for the target document.

2. The computer-readable storage medium of claim 1 further comprising instructions to, when the target document has one or more current recipients, select documents with associated entities in common with the current recipients, and wherein the identified entities include entities associated with those selected documents that are not current recipients.

3. The computer-readable storage medium of claim 1 further comprising instructions to, when a recipient query is submitted for the target document, search for entities that match the recipient query, and wherein the identified entities include entities that match the recipient query.

4. The computer-readable storage medium of claim 1 wherein the document data is selected from the group consisting of entities associated with the document, content of the document, subject of the document, title of the document, and attachment to the document.

5. The computer-readable storage medium of claim 1 wherein the suggestion is provided by instructions that display names of the identified entities and further comprising instructions that receive a selection of an identified entity and add the selected identified entity as a current recipient of the target document.

6. The computer-readable storage medium of claim 1 wherein the target document is an electronic mail message with one or more current recipients and a subject, and further comprising instructions that select electronic mail messages with parties in common with the current recipients, wherein the document data includes the subject, and wherein the identified entities include parties to those selected electronic mail messages.

7. The computer-readable storage medium of claim 1 wherein the target document is an electronic mail message and the corpus includes documents that are not electronic mail messages but have associated entities and wherein the provided suggestion further suggests that an entity associated with a document that is not an electronic mail message be considered as a recipient for the electronic mail message.

8. The computer-readable storage medium of claim 1 wherein the target document is an electronic mail message with an attachment and further comprising instructions that compare the attachment with document data of documents in a corpus of documents to select documents that are similar to the attachment and wherein the identified entities include entities associated with the selected documents.

9. The computer-readable storage medium of claim 1 wherein the target document is received from outside of an organization, the identified entities are within the organization, and the target document is forwarded to one of the identified entities.

10. A method performed by a computing device for suggesting recipients of a target electronic communication, the method comprising:
prompting for entry of a recipient of the target electronic communication;
receiving a response to the prompting;
when the response matches an entity in an address store, adding the matching entity as a recipient of the target electronic communication; and
when the response does not match an entity in the address store, identifying an entity to suggest as a recipient of the target electronic communication by using the response as a recipient query to identify an entity that matches the recipient query.

11. The method of claim 10 wherein the identifying of an entity includes submitting the response as a search query to a people finder search engine.

12. The method of claim 10 wherein the identifying of an entity includes searching a profile store of people associated with an organization to identify people who match the recipient query.

13. The method of claim 10 further comprising identifying electronic mail messages that are similar to the target electronic communication and identifying parties to the identified electronic mail messages to suggest as recipients of the target electronic communication.

14. The method of claim 10 wherein the response is received via a voice-based user interface.

15. The method of claim 10 wherein the prompting includes displaying a field for entry of a name of a recipient of the electronic communication.

16. The method of claim 10 wherein the target electronic communication is received from outside of an organization, the identified entity is within the organization, and the identified entity is added as a recipient of the target electronic communication.

17. A computing system for suggesting recipients for a target electronic mail message, comprising:
a memory storing computer-executable instructions that include instructions to
receive from a user document data of the target electronic mail message;
identify electronic mail messages that are similar to the target electronic mail message by comparing the document data of the target electronic mail message to document data of electronic mail messages of the user;
identify entities that are parties to the identified electronic mail messages;
receive from the user a recipient query via a user interface for entering the name of a recipient;
identify entities that match the recipient query; and
provide a suggestion of one or more of the identified entities as recipients for the target document; and
a processor for executing the computer-executable instructions stored in the memory.

18. The computing system of claim 17 wherein the memory further stores instructions to, when the target electronic mail message has one or more current recipients, identify electronic mail messages with one or more parties that are current recipients and identify entities that are parties to the electronic mail messages that are not current recipients.

19. The computing system of claim 17 wherein the instructions that identify entities that match the recipient query search a profile store of an organization.

20. The computing system of the 17 wherein the instructions that identify electronic mail messages that are similar further compare an attachment to the target electronic mail message to document data of the electronic mail messages of the user.
